(19) United States
(12) Patent Application Publication
(10) Pub. No.: US 2017/0023208 A1
(43) Pub. Date: Jan. 26, 2017

(54) METHOD AND APPARATUS FOR INDIRECT LIGHTING

(71) Applicant: JST Performance, LLC, Gilbert, AZ (US)

(72) Inventor: Edgar A. Madril, Mesa, AZ (US)

(73) Assignee: JST Performance, LLC, Gilbert, AZ (US)

(21) Appl. No.: 15/214,852

(22) Filed: Jul. 20, 2016

Related U.S. Application Data
(60) Provisional application No. 62/195,661, filed on Jul. 22, 2015.

(51) Int. Cl. F21V 7/09; F21V 7/00

(52) U.S. Cl. CPC F21V 7/09; F21V 7/0016; F21V 7/0066; F21Y 2115/10

(57) ABSTRACT

An apparatus may comprise a fixture having an opening, one or more LEDs, and a reflector. The opening may be a slot, and may have a predefined area. The LEDs may emit light away from the opening. The reflector may have a plurality of surface shapes, and may include one or more ellipsoidal shapes, one or more flat shapes, and one or more parabolic shapes. The LEDs may be positioned so that light may be reflected through the opening. Light may reflect from the surface shapes one or more times individually or collectively. A transparent media may cover the opening, and may include pigments. The fixture may include a plurality of openings, a plurality of transparent media, a plurality of reflectors, and a plurality of PCBs. Light may be emitted from the opening according to a span of emission, and may produce a particular beam pattern.

### FIELD OF THE INVENTION

The present invention generally relates to lighting systems, and more particularly to indirect lighting systems.

### BACKGROUND

Light emitting diodes (LEDs) have been utilized since about the 1960s. However, for the first few decades of use, the relatively low light output and narrow range of colored illumination limited the LED utilization role to specialized applications (e.g., indicator lamps). As light output improved, LED utilization within other lighting systems, such as within LED “EXIT” signs and LED traffic signals, began to increase. Over the last several years, the white light output capacity of LEDs has more than tripled, thereby allowing the LED to become the lighting solution of choice for a wide range of lighting solutions.

Lighting systems may include LEDs, a printed circuit board (PCB), and associated control circuitry and may be mounted within a fixture (e.g., light bar). During operation, the LED emits light rays in any of a plurality of directions. Some emitted light rays exit the fixture through one or more openings, while other light rays are prevented from exiting by walls of the fixture.

Efforts continue, therefore, to provide LED and reflector configurations within the light fixture that maximizes an amount of light that is allowed to exit the fixture while, at the same time, forming the maximized amount of light into a specialized beam pattern.

### SUMMARY

In accordance with one embodiment of the invention, an apparatus comprises a fixture including a slot. The apparatus further includes one or more LEDs positioned within the fixture and configured to emit an effective span of light, such that the effective span of light does not pass through the slot. The apparatus further includes a reflector positioned within the fixture and configured to produce subtended light by subtending the effective span of light, such that the subtended light passes through the slot. The reflector is formed of at least one ellipsoidal surface, at least one flat surface, and at least one parabolic surface.

In accordance with another embodiment of the invention, an apparatus comprises a fixture including a slot with a predefined area formed by a length and a width. The apparatus further includes one or more LEDs positioned within the fixture and configured to emit an effective span of light, such that the effective span of light does not pass through the slot. The apparatus further includes a reflector positioned within the fixture and configured to produce subtended light by subtending the effective span of light, such that substantially all the subtended light passes through the predefined area of the slot. The reflector is formed of at least one ellipsoidal surface, and one or more non-ellipsoidal surfaces.

In accordance with another embodiment of the invention, a method comprises emitting light from one or more LEDs toward a reflector. The method further includes subtending the emitted light from at least one ellipsoidal surface, at least two flat surfaces, and at least two parabolic surfaces of the reflector through a slot of a fixture.

### BRIEF DESCRIPTION OF THE DRAWINGS

Various aspects and advantages of the invention will become apparent upon review of the following detailed description and upon reference to the drawings in which:

FIG. 1 illustrates a fixture in accordance with one embodiment of the present invention;

FIG. 2 illustrates a cross-section of the fixture of FIG. 1;

FIG. 3A illustrates a reflector in accordance with one embodiment of the present invention;

FIG. 3B illustrates a portion of an ellipsoid taken for use as part of the reflector of FIG. 3A;

FIG. 4A illustrates a distribution of light rays in accordance with one embodiment of the invention;

4B illustrates another distribution of light rays in accordance with another embodiment of the invention;

FIG. 5 illustrates a distribution of light rays in accordance with another embodiment of the invention;

FIG. 6 illustrates a distribution of light rays in accordance with another embodiment of the invention;

FIG. 7 illustrates a fixture in accordance with another embodiment of the present invention;

FIG. 8 illustrates a fixture in accordance with another embodiment of the present invention;

FIG. 9 illustrates a fixture in accordance with another embodiment of the present invention;

FIG. 10 illustrates a projected beam pattern in accordance with one embodiment of the present invention;

FIG. 11 illustrates a projected beam pattern in accordance with another embodiment of the present invention;

FIG. 12 illustrates a projected beam pattern in accordance with another embodiment of the present invention;

FIG. 13 illustrates a projected beam pattern in accordance with another embodiment of the present invention; and

FIG. 14 illustrates a projected beam pattern in accordance with another embodiment of the present invention.

### DETAILED DESCRIPTION

Generally, the various embodiments of the present invention are applied to an apparatus for directly or indirectly emitting light from a fixture. A fixture may include a compartment with an interior cavity which is substantially sealed. One or more light emitting diodes (LEDs), a printed circuit board assembly (PCBA), and associated circuitry may be contained within the interior cavity. Due to the sealed nature of the interior cavity, moisture and other contaminants may be prevented from entering and adversely affecting the LED, PCBA, and associated circuitry.

The fixture may further include an opening, which may extend entirely through a wall of the fixture. The opening may be rectangular, or any other suitable shape. Further, the opening may be a slot, and may have tapered or rounded edges. The opening may be covered by a transparent media. The transparent media may allow light to pass therethrough. Light may pass from the interior cavity within the compartment through the transparent media to an exterior of the fixture.

A reflector may be positioned within the compartment of the fixture. The reflector may be positioned to reflect light emitted by the LEDs through the opening of the fixture. The light emitted by the LEDs may be directed so that at least some light passes directly from the LEDs through the opening of the fixture. Alternatively, the light emitted by the LEDs may be directed so that all the light from the LEDs is reflected before passing through the opening of the fixture. The LEDs may be positioned within the fixture to be visible from the exterior of the fixture through the opening. Alternatively, the LEDs may be positioned within the fixture so that they are not visible from the exterior of the fixture through the opening.

The reflector may be formed of any suitable material, and further may include a coating. Materials used for the reflector and/or the reflector coating may be selected to optimize light reflectivity, reduce light absorption, or to change thermal transfer coefficients between the interior cavity and the exterior of the fixture.

The reflector may be formed of one or more of a plurality of surface shapes. For example, the reflector may be one or more of a parabolic, spherical, ellipsoidal, cylindrical, conical, toroidal, and a flat shape, or a plurality of one or more of these shapes. For example, the reflector may include a parabolic shape and a flat shape, collectively. In another example, the reflector may include an ellipsoidal shape, and a flat shape. In another example, the reflector may include an ellipsoidal shape and a parabolic shape. In another example, the reflector may include an ellipsoidal shape, two flat shapes, and two parabolic shapes. One of skill in the art will appreciate that various combinations are possible.

Shapes may be selected to optimize light reflection in a particular direction (e.g., diffused), producing a particular pattern (e.g., beam pattern), or to satisfy any other criteria (e.g., government, industry, or associational regulatory standards).

The LEDs may be positioned with respect to the reflector to optimize passage of light through the opening. For example, the LEDs may be positioned at one end of the reflector, at a perimeter of the reflector, and/or away from a principle focal axis of a surface of the reflector (e.g., where the surface is selected to have a curvature with an associated focal axis). Further, the LED may emit light in a predetermined direction (e.g., having an angular span of emission).

The opening may be sized to allow light to pass through. Further the opening may have a predefined area. The opening may be sized to have a dimensional length greater than, equal to, or less than a dimensional width (e.g., a slot). For example, the ratio of dimensional length to width may be selectable (e.g., 1:1, 1:5, 5:1, 50:1). The opening may be sized so that the width is just large enough to allow substantially all of the light emitted from the LEDs to pass through the opening, such that a further reduction in the width of the opening may reduce luminescence outside the fixture.

Light rays reflecting from the reflector may reflect once, twice, three times, or more depending on the shape of the reflector. The reflector may be shaped to cause reflecting light to be emitted through the opening according to a different span of light ray emission than the span of emission of the LED. Light passing through the opening may have a first span along a first plane parallel to a width of the opening, and may further have a second span along a second plane parallel to a length of the opening. The first and second spans may be equal or different. Further, the first and second spans may be adjusted by changing the shape and/or size of the reflector.

The fixture may have more than one opening. Each of the one or more openings may be oriented in a series or in an array. Each of the one or more openings may have the same or different dimensional widths and lengths. Further, the fixture may have more than one reflector. Each of the one or more reflectors may be oriented in a series or in an array. Each of the one or more reflectors may have the same or different dimensional widths and lengths. Further, the fixture may have more than one PCBA. Each of the one or more PCBAs may be oriented in a series or in an array. Each of the one or more PCBAs may have the same or different dimensional widths and lengths. The fixture may be as long or short and as wide or narrow to accommodate any combination of the one or more openings, reflectors, and PCBAs. Further, each PCBA and/or each reflector may have at least one LED associated therewith. For example each PCBA and/or reflector may have two or more LEDs.

The fixture may be positioned with respect to a surface to be illuminated. The shape of a corresponding beam pattern may be determined by the proximity and angle of the fixture with respect to the surface. In one embodiment, one or more fixtures may be oriented with respect to one or more surfaces. The fixture may be capable of emitting light having a predetermined beam pattern. Furthermore, the reflector contained within the fixture may be shaped to reduce or eliminate defects in the beam pattern.

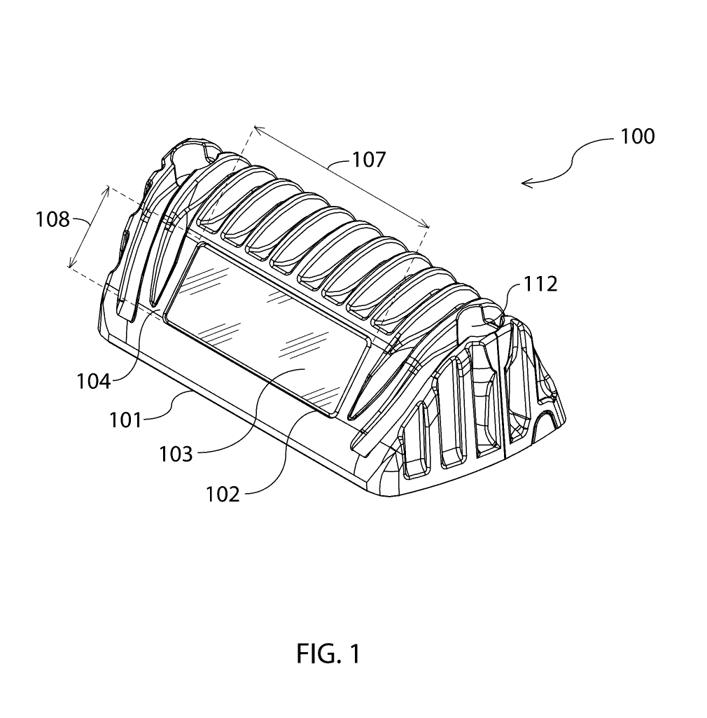

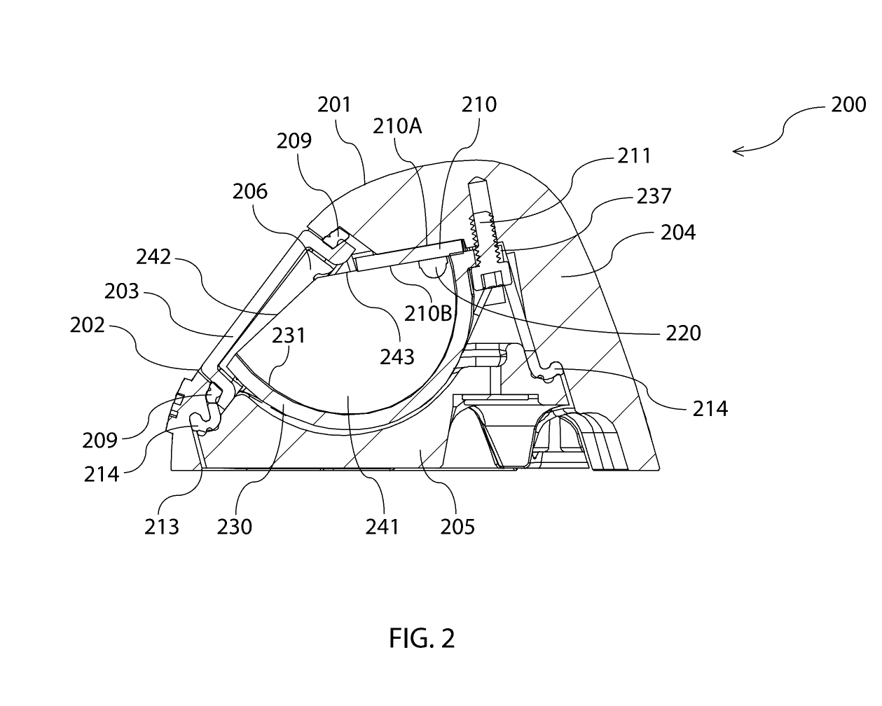

As illustrated in FIG. 1, a light fixture 100 is exemplified for emitting light within a particular beam pattern. Light fixture 100 may include a housing 101 with a sealed interior cavity (e.g., interior cavity 206 of FIG. 2). One or more light emitting diodes (LEDs), and one or more printed circuit board assemblies (PCBAs) with control circuitry may be contained within the interior cavity. Due to the sealed nature of the interior cavity, moisture and other contaminants may be prevented from entering and adversely affecting operation of the LEDs, and/or the control circuitry of the PCBAs.

Light fixture 100 may further include an opening 102 for allowing the passage of light from the interior cavity, such that opening 102 may extend entirely through a wall 104 of housing 101. The opening 102 may be any suitable shape. For example, opening 102 may be square, rectangular, slotted, circular, oval, or any other shape. In another example, opening 102 may have tapered or rounded edges and may further have tapered or rounded corners. In another example, opening 102 may have a predefined area. In another example, where opening 102 is rectangular in shape, opening 102 may have a length 107 and a width 108.

Length 107 and width 108 may be appropriately sized such that substantially all the light emitted by the one or more LEDs passes through opening 102. Length 107 may be greater than, equal to, or less than width 108. For example, a ratio of length 107 to width 108 may be between about 1:50 and about 50:1 (e.g., about 2.75:1). In another example, length 107 may be between about 0.5 inches and about 20 inches (e.g., about 2.31 inches). In another example, width 108 may be between about 0.2 inches and about 10 inches (e.g., about 0.85 inches).

Opening 102 may be filled, covered, and/or enclosed by a media 103, which may allow at least a portion of the emitted light to pass through opening 102. For example, media 103 may be one or more of transparent, translucent, and/or opaque to enable regulation of light through opening 102. Further, opening 102 may be sealed by media 103 to prevent passage of moisture and other contaminants into the interior cavity (e.g., via gasket 209 of FIG. 2). Media 103 may be formed of any suitable material to allow light emitted by the LEDs to pass through opening 102 (e.g., glass, plastic, etc.). For example, light may pass from the interior cavity of housing 101 and through media 103 to an exterior of light fixture 100. In another example, media 103 may enable light to pass from the exterior of light fixture 100 into the interior cavity. In another example, media 103 may include one or more pigments and/or colors to filter one or more light colors passing through opening 102.

Housing 101 may include one or more apertures 112 to enable light fixture 100 to be secured to a mounting surface (not shown). For example, mounting surface may be any one or more of a vertical surface, a horizontal surface, and/or an inclined surface.

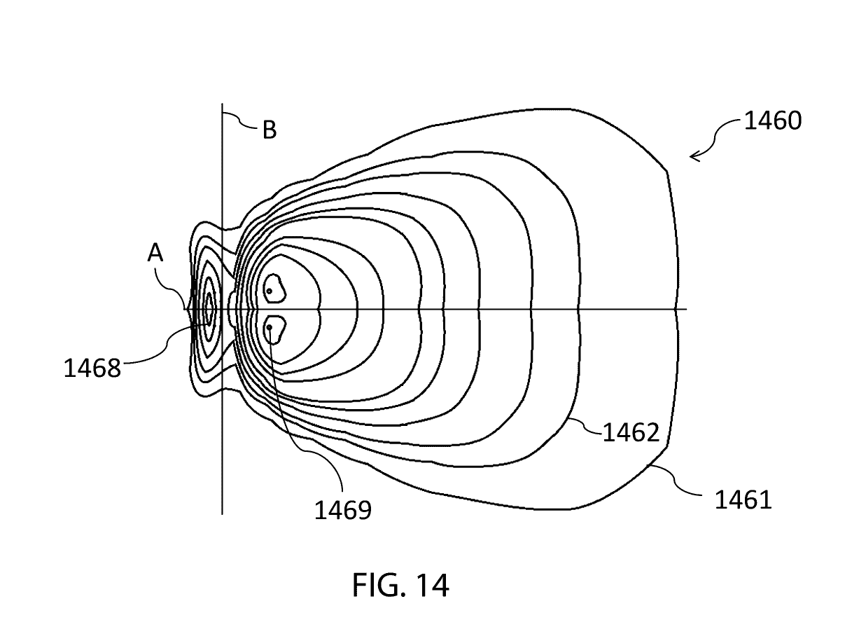

As illustrated in FIG. 2, a fixture 200 is exemplified for emitting light within a particular beam pattern (e.g., beam pattern 1460 of FIG. 14). Fixture 200 may include a housing 201 with an interior cavity 206 for receiving various components of fixture 200. For example, interior cavity 206 may receive a printed circuit board assembly (e.g., PCBA 210), one or more light emitting diodes (e.g., LEDs 220), and a reflective surface (e.g., reflector 230).

Housing 201 may include a wall 204 surrounding interior cavity 206, such that interior cavity 206 is enclosed by wall 204. An opening 207 may extend entirely through wall 204 to facilitate access to interior cavity 206 for placement of various components of the fixture 200 (e.g., reflector 230). Opening 213 may be substantially covered, enclosed, and/or sealed by a base portion 205 to prevent entrance of moisture and/or other contaminants. For example, base portion 205 may be sealed to wall 204 by one or more gaskets 214. Base portion 205 may be removably attachable to wall 204, and may be coupled to wall 204 by any suitable fastening structure (e.g., fasteners, not shown).

An opening 202 may extend entirely through wall 204 to enable the passage of light into and/or out of interior cavity 206. A transparent media 203 may substantially cover, enclose, and/or seal opening 202. For example, transparent media 203 may be sealed to wall 204 within opening 202 by a gasket 209 extending around a perimeter of opening 202. Opening 202 may have a predefined area to enable passage of a predetermined amount of light emitted by the LEDs. The predefined area may be sized to allow light emitted by one or more LEDs 220 to pass through the opening 202.

PCBA 210 may be mounted entirely within interior cavity 206. Further, PCBA 210 may be mounted to wall portion 204 of housing 201. PCBA 210 may be oriented so that a first side 210A of PCBA 210 is in contact with wall portion 204, and so that a second side 210B of PCBA 210 faces away from wall 204 (e.g., toward reflector 230). PCBA 210 may further be electrically coupled to a power source (not shown) positioned exterior to the fixture 200 (e.g., via a power cord, not shown).

Reflector 230 may be positioned within interior cavity 206 to subtend light emitted by LEDs 220 through opening 202 (e.g., through media 203). For example, reflector 230 may be positioned between wall 204 and base portion 205. In another example, reflector 230 may be positioned between PCBA 210 and base portion 205. Reflector 230 may be positioned to engage wall 204, base portion 205, PCBA 210, media 203, and/or any combination thereof. In another example, reflector 230 may be locked and/or secured in place by any suitable locking and/or securing device (e.g., a locking element 237 engaged by a threaded screw 211).

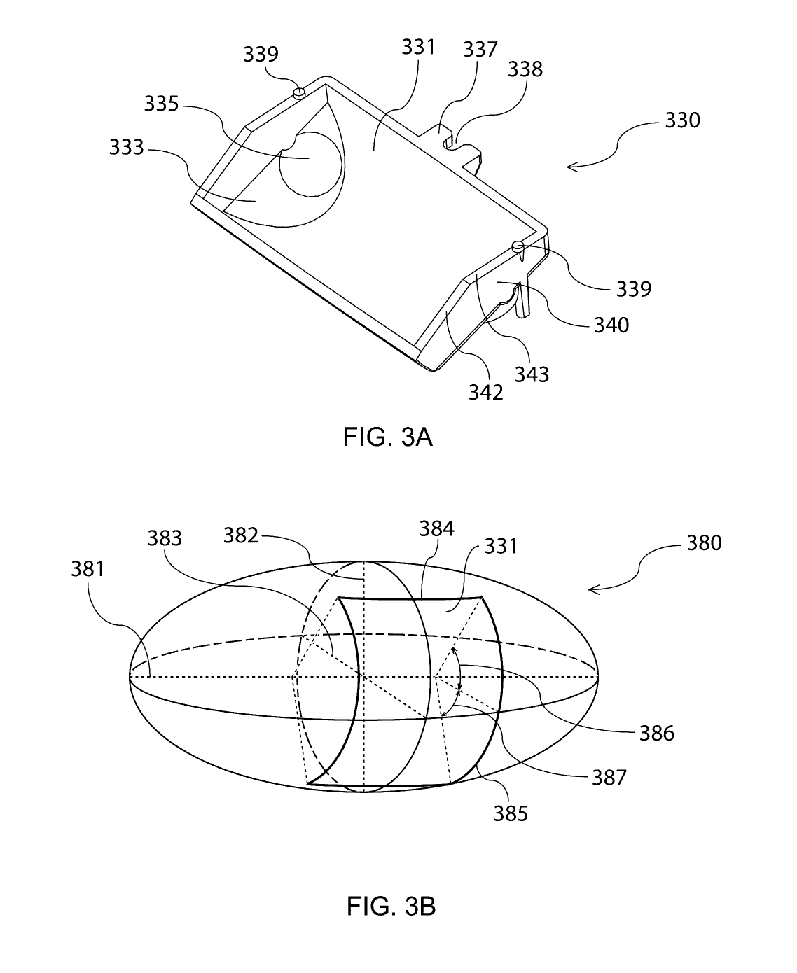

Reflector 230 may be formed of one or more of a plurality of surface shapes (e.g., parabolic, spherical, ellipsoidal, cylindrical, conical, toroidal, and/or flat shapes). For example, reflector 230 may include at least one ellipsoidal surface 231 (e.g., representing an interior surface of reflector 230). In another example, a reflector may include at least one flat surface (e.g., flat surface 333 of reflector 330 as shown in FIG. 3). In another example, a reflector may include at least one parabolic surface (e.g., parabolic surface 335 of reflector 330 as shown in FIG. 3).

Reflector 230 may be in the form of a three-dimensional body defining an internal space 241. Further, the three-dimensional body may include an opening and a closed portion formed of the surface shapes (e.g., ellipsoidal surface 231 forming a closed portion). Reflector 230 is shown having at least one opening (e.g., comprising forward opening 242 and rearward opening 243). Although shown with corresponding lines, forward and rearward openings 242, 243 are understood to allow the passage of light therethrough (e.g., openings 242 and 243 may form a single aperture in reflector 230 extending into internal space 241).

LEDs 220 may be positioned with respect to the reflector 230 to optimize passage of light through opening 202 of fixture 200. For example, LEDs 220 may be positioned at one end of reflector 230. In another example, LEDs 220 may be positioned at a perimeter of reflector 230. In another example, LEDs 220 may be positioned away from a focal axis (e.g. intermediate axis 1583 of FIG. 15) of the ellipsoidal surface 231. In another example, LEDs 220 may be positioned on a second side 210B of PCBA 210. In another example, LEDs 220 may be positioned to extend into internal space 241 of reflector 230.

LEDs 220 may be selected to optimize performance of fixture 200. For example, LEDs 220 may emit light at wavelengths within or outside the visible spectrum (e.g., ultraviolet and infrared). In another example, LEDs 220 may emit light having multiple wavelengths (e.g., white light). In another example, LEDs 220 may emit light having wavelengths in the visible spectrum (e.g., red, orange, yellow, green, blue, indigo and violet).

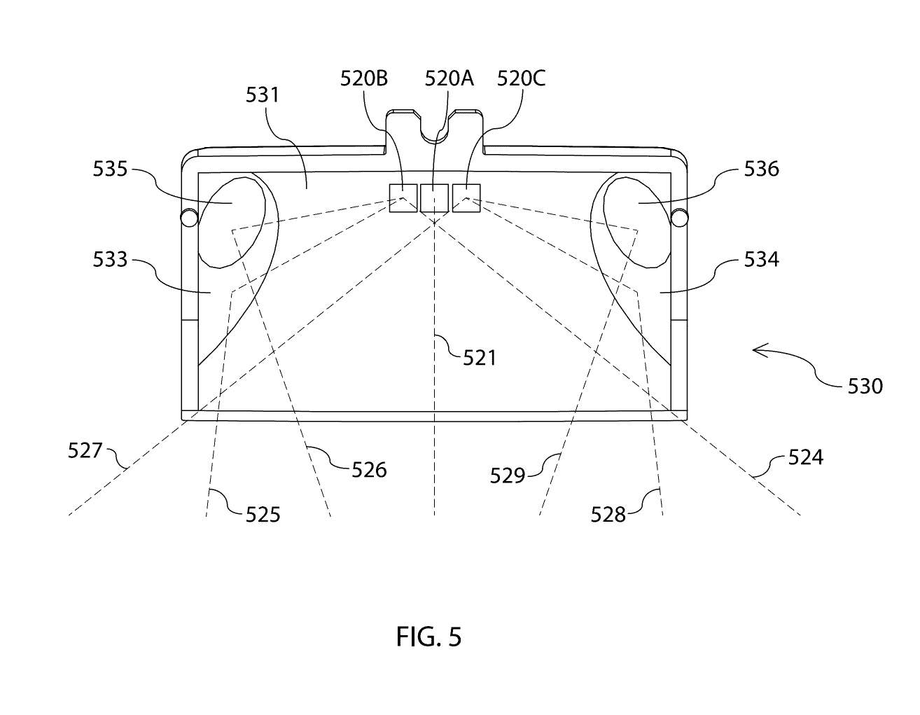

As illustrated in FIG. 3A, a reflector 330 may be formed of one or more of a plurality of surface shapes (e.g., parabolic, spherical, ellipsoidal, cylindrical, conical, toroidal, or a flat shape). For example, a reflector may include a parabolic shape and a flat shape, collectively. In another example, a reflector may include an ellipsoidal shape, and a flat shape. In another example, a reflector may include an ellipsoidal shape and a parabolic shape. A person of ordinary skill in the art will appreciate that various combinations are possible. In a specific example, reflector 330 may include an ellipsoidal shape 331, a first flat shape 333, a second flat shape (e.g., second flat shape 534 of FIG. 5), a first parabolic shape 335, and a second parabolic shape (e.g., second parabolic shape 536 of FIG. 5).

The shapes used and the relative orientation of the shapes with respect to each other may be selected to optimize light reflection in a particular direction (e.g., diffused), producing a particular pattern (e.g., beam pattern), or to satisfy any other criteria (e.g., government, industry, or associational regulatory standards). For example, parabolic shape 335 may be either partially or entirely contained within flat shape 333. Further, flat shape 333 and parabolic shape 335 may be oriented at one or more angles with respect to the ellipsoidal shape 331. A person of ordinary skill in the art will appreciate that various orientations are possible.

Reflector 330 may be formed of any suitable material (e.g., plastic, composite, metal), and further may include a coating (e.g., a reflective coating). Materials used for the reflector and/or the coating may be selected to optimize light reflectivity, to reduce light absorption, and/or to change thermal transfer coefficients between the interior cavity and the exterior of the fixture.

Reflector 330 may include one or more sidewalls 340 to facilitate alignment of reflector 330 within a housing (e.g., housing 201 of FIG. 2), to a PCBA (e.g., PCBA 210 of FIG. 2), or to both. Sidewalls 340 may be reflective or non-reflective. Alternatively, a reflector may be manufactured without sidewalls. Sidewalls 340 may include a forward portion 342 and a rearward portion 343. Forward portion 342 and rearward portion 343 may facilitate in alignment of the reflector 330 with respect to a housing, a PCBA, or both. Further, forward portion 342 may be symmetrical to rearward portion 343, or may be asymmetrical to rearward portion 343.

Reflector 330 may include a locking element 337 with a groove 338 to enable securement within the housing (e.g., groove 338 may receive threaded screw 211 of FIG. 2). Further, reflector 330 may include one or more alignment elements 339 secured to reflector 330 or formed integrally therewith to facilitate alignment of reflector 330 with the housing (e.g., housing 201 of FIG. 2), with a PCB (e.g., PCB 210 of FIG. 2), or both.

As illustrated in FIG. 3B, the ellipsoidal surface 331 of FIG. 3A may be a portion of an ellipsoid with a major axis 381 of predetermined length, a minor axis 382 of predetermined length, and an intermediate axis 383 of predetermined length. The ratio of major axis 381 to minor axis 382 may be between about 5:1 and about 15:1 (e.g., about 10.5:1). Further, the ratio of major axis 381 to intermediate axis 383 may be between about 5:1 and about 15:1 (e.g., about 9:1).

The portion of ellipsoid 380 selected for reflector 330 may further have an arc length 384 corresponding to major axis 381, such that the ratio of major axis 381 to the corresponding arc length 384 is between about 2:1 and about 5:1 (e.g., about 3.5:1). The portion of ellipsoid 380 may further have an arc length 385 corresponding to minor axis 382, such that the ratio of minor axis 382 to the corresponding arc length 385 is between about 1:3 and about 1:1 (e.g., about 1:2). Thus, elliptical surface 331 of reflector 330 may be scalable to any dimension for use with any lighting application (e.g., including non-LED lighting applications).

Elliptical surface 331 may be formed by a portion of ellipsoid 380 spanning a linear distance of major axis 381. For example, the linear distance may extend from one end of major axis 381 to some distance less than or equal to the length of major axis 381. Alternatively, the linear distance may extend within major axis 381 (e.g., as exemplified in FIG. 3B). Further, the linear distance may be symmetric about a center point of major axis 381 (e.g., corresponding to a center point of ellipsoid 380).

Elliptical surface 331 may be formed by a portion of ellipsoid 380 spanning an angle of rotation about major axis 381 (e.g., an angle including angles 386, 387). For example, angle 386 may represent a rotation from intermediate axis 383 toward minor axis 382. In another example, angle 387 may represent a rotation from intermediate axis 383 toward minor axis 382, but oppositely to angle 386. Angle 387 may be less than, equal to, or greater than angle 386.

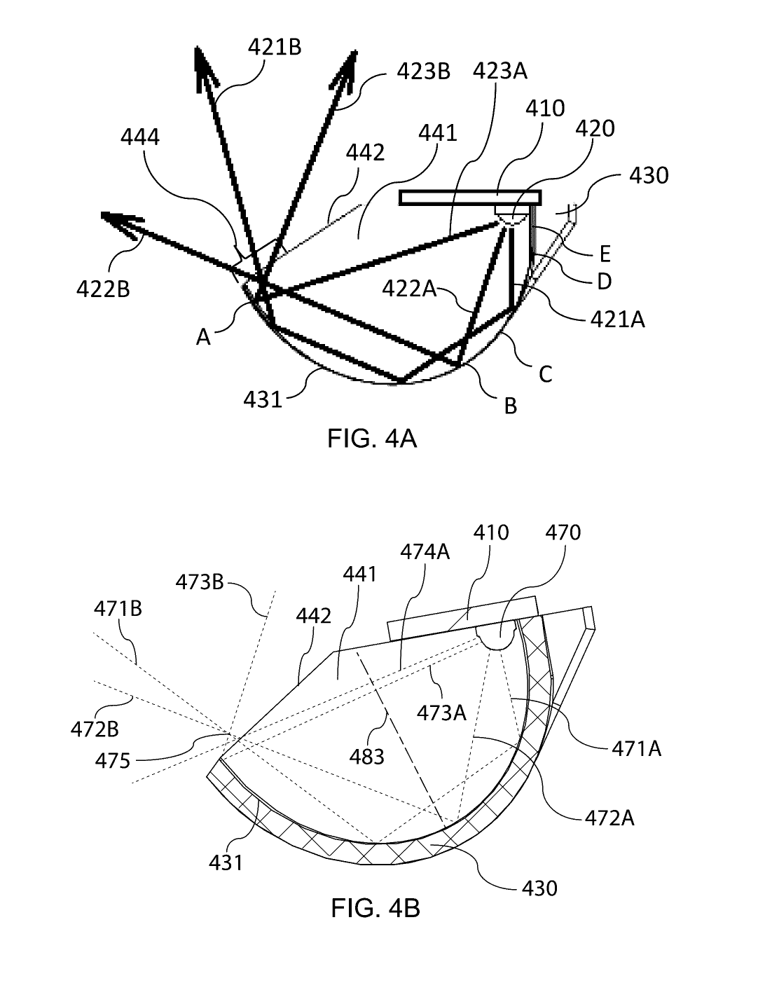

Intermediate axis 383 may be at least partially represented by axis of symmetry 483 of FIG. 4. As illustrated in FIG. 4A, light (e.g., light rays 421A-423A) may be emitted by one or more LEDs 420 within a reflector 430. LEDs 420 may be secured to a PCBA 410, or may be mounted integrally therewith. Reflector 430 may be oriented to contact PCBA 410, or may be spaced some distance from PCBA 410. Where reflector 430 and PCB 410 are in contact, LEDs 420 may extend into an internal space 441 of reflector 430. In another embodiment, a reflector may be spaced far enough from a PCB for one or more LEDs to be positioned so that they do not extend into an internal space of the reflector.

LEDs 420 may be capable of emitting light in a predetermined direction. For example, LEDs 420 may emit light across an effective span of between about 90 degrees and about 180 degrees (e.g., 120 degrees). An effective span may represent the span in which light is emitted above a specified intensity. Although FIG. 4A illustrates a single cross-sectional plane of reflector 430 with only three light rays, a person of ordinary skill in the art will appreciate that LEDs 420 may emit light around and throughout an entire perimeter (i.e., in three dimensions). Thus the light ray distribution may be significantly more complex than that illustrated in FIG. 4A. Furthermore, it is understood that light rays may be emitted throughout the effective span and beyond the effective span at intensities below the specified intensity (e.g., between light ray 422A and light ray 423A).

Light rays 421A-423A may serve as examples of light rays emitted within one of the effective span and/or a total span of light emitted from LEDs 420. Further, each light ray may represent a boundary within reflector 430 to distinguish various ways in which the emitted light may be subtended.

For example, a first light ray 421A may represent light emitted from LEDs 420 at an axis of symmetry extending from LEDs 420 (e.g., an axis of symmetry extending through the effective span of light emission). First light ray 421A is illustrated as proceeding downward from LEDs 420 and substantially perpendicularly from PCBA 410. Light ray 421A may be subtended (e.g., reflected) by reflector 430 three times due to the curvature of reflector 430 (e.g., having an ellipsoidal surface 431) before proceeding out of reflector 430 through a forward opening 442. First light ray 421A may be passed out of internal space 441 as first subtended light ray 421B. Where reflector 430 is positioned within a fixture (e.g., fixture 200 of FIG. 2), subtended light ray 421B may pass through an opening of the fixture (e.g., through opening 202 of FIG. 2).

A third light ray 423A may represent light emitted in a direction farthest from first light ray 421A (e.g., at an angle greater than which LED 420 may not emit light). For example, the angle between first light ray 421A and third light ray 423A may be between about 45 degrees and about 90 degrees (e.g., about 60 degrees). For example, a light ray disposed oppositely to third light ray 423A may be emitted at about sixty degrees in the opposite direction (e.g., opposite the axis of symmetry of LEDs 420). Although an oppositely disposed light ray is not illustrated, a person of ordinary skill in the art may approximate its path.

Third light ray 423A may proceed to a single point of reflection from the ellipsoidal surface 431 before passing out of internal space 441 (e.g., becoming third subtended light ray 423B). In the embodiment of FIG. 4B, LEDs 470 may be oriented so that a fourth light ray (e.g., representing a maximum span in a range of light emission) may pass directly out of an internal space 441 without reflecting from reflector 430.

Between first light ray 421A and third light ray 423A, the LED 420 may emit a plurality of light rays. Further light rays may be emitted at any point between first light ray 421A and any extreme light ray around the entire perimeter of LED 420. For example, second light ray 422A may be emitted, and may proceed to a single point of reflection from ellipsoidal surface 431 before passing out of internal space 441 (e.g., becoming second subtended light ray 422B).

Subtended light rays 421B-423B may serve as examples of light ray boundaries of subtended light resulting from corresponding light rays 421A-423A. For example, third subtended light ray 423B may proceed out of reflector 430 in a first direction (as exemplified in FIG. 4A). In another example, second subtended light ray 422B may proceed out of reflector 430 in a second direction (as exemplified in FIG. 4A). The approximate angular difference between subtended light rays 423B and 422B (e.g., between the first and second directions) may represent a subtended span of light between about 60 degrees and about 120 degrees (e.g., about 90 degrees, as exemplified in FIG. 4A).

Thus, in a specific embodiment, a portion of an approximately one hundred and twenty degree span of emission of light from LEDs 420 may be converted into an approximately ninety degree angular span of emission from the internal space 441 (e.g., through opening 202 of FIG. 2).

The angular span of subtended light ray emission from internal space 441 may be varied by changing the reflector. For example, the angular span of subtended light ray emission may be varied by changing the curvature of ellipsoidal surface 431 (e.g., by lengthening or shortening a major, a minor, and/or an intermediate axis of the ellipsoidal surface, or by selecting a different shape). All or substantially all of the intermediate light rays may be emitted from the internal space 441 approximately within the angular span (e.g., approximately within a ninety degree angular span between exiting light rays 422B and 423B). Thus, by optimizing the curvature of the ellipsoidal surface, a light ray distribution may be designed with a specified angular span. The angular span may be configured to achieve a particular beam pattern.

As noted above, some light rays may be subtended (e.g., reflected) only once (e.g., second light ray 422A, third light ray 423A). Further, some light rays may be subtended two, three, four, or more times (e.g., first light ray 421A is subtended three times), depending on the shape of the reflective surface used.

For example, light rays emitted by LEDs 420 may reflect only once along a path between point A and point B, and may pass out of internal space 441 without any further reflection (e.g., reflected once). Point A may represent the furthest point of travel with which light emitted from LED 420 can reflect from ellipsoidal surface 431. Further, light rays reflecting in the range between point A and point B may be passed out of internal space 441 approximately in the range between third subtended light ray 423B and second subtended light ray 422B, respectively.

In another example, light rays emitted by LEDs 420 may reflect for the first time along a path between point B and point C, and may reflect at least once more before passing out of internal space 441 (e.g., reflected twice). Accordingly, point B may be a transitional point between light reflecting once and light reflecting twice. Further, light rays reflecting in the range between point B and point C may be passed out of internal space 441 approximately in the range between third subtended light ray 423B and second subtended light ray 422B, respectively (e.g., within a similar range to light rays reflecting between point A and point B).

In yet another example, light rays emitted by LEDs 420 may reflect for the first time along a path between point C and point D, and may reflect at least twice more before passing out of internal space 441 (e.g., reflected three times). Accordingly, point C may be a transitional point between light reflecting twice and light reflecting three times. Further, light rays reflecting in the range between point C and point D may be passed out of internal space 441 approximately in the range between third subtended light ray 423B and second subtended light ray 422B, respectively (e.g., within a similar range to light rays reflecting between point A and point B).

In yet another example, light rays emitted by LED 420 may reflect for the first time along a path between point D and point E, and may reflect at least once more before passing out of internal space 441 (e.g., reflected twice). Accordingly, point D may be a transitional point between light reflecting three times and light reflecting twice. Point E may represent the furthest point of travel with which light emitted from LED 420 can reflect from ellipsoidal surface 431 (i.e., oppositely to point A). Further, light rays reflecting in the range between point D and point E may be passed out of internal space 441 approximately in the range between third subtended light ray 423B and second subtended light ray 422B, respectively (e.g., within a similar range to light rays reflecting between point A and point B).

Where light is emitted according to each of the above examples simultaneously, the light rays reflecting along respective paths between points A, B, C, D, and E may each create a span of light emission. For example, the path between points A and B may create a first span, the path between points B and C may create a second span, the path between points C and D may create a third span, and the path between points D and E may create a fourth span. Each of the first, second, third, and fourth spans may be overlapping with at least one other span. Further, each of the first, second, third, and fourth spans may be overlapping with every other span (e.g., approximately between third and second subtended light rays 423B, 422B). Accordingly, the luminous intensity of light emitted from internal space 441 may be increased where the first, second, third, and fourth spans are overlapping. In this way, the reflector 430 may optimize light emission by passing reflected light from the internal space 441 in a tight and precise range of emission.

Opening 442 of reflector 430 may be oriented adjacent to an opening of a fixture (e.g., opening 202 of fixture 200 in FIG. 2). Substantially all, or all of the light rays emitted by LEDs 420 may pass from reflector 430 through forward opening 442. Further, all, substantially all, or a significant portion of the light rays emitted by LEDs 420 may pass from reflector 430 across a much smaller distance 444.

Distance 444 may be greater than, equal to, or less than the width of forward opening 442. Further, distance 444 may be less than seventy-five percent the width of forward opening 442. Further, distance 444 may be less than fifty percent the width of forward opening 442. Further, distance 444 may be less than twenty-five percent the width of forward opening 442. Where light rays pass through a smaller distance 444, the light rays may also pass through a correspondingly narrower width of an opening of a fixture (e.g., width 208 of opening 202 in FIG. 2). Accordingly, the width of an opening of a fixture may be wider, equal to, or narrower than forward opening 442 of reflector 430.

In the embodiment of FIG. 4B, one or more LEDs 470 may be disposed in the reflector 430 in a different configuration that that exemplified in FIG. 4A. For example, a first light ray 471A may extend from LEDs 470 substantially along an axis of symmetry of the LEDs 470. First light ray 471A may be subtended by reflector 430 twice before proceeding out of reflector 430 through forward opening 442. First light ray 471A may be passed out of internal space 441 as first subtended light ray 471B. In another example, a second light ray 472A may represent light emitted from LEDs 470 at a first angle of inclination with respect to first light ray 471A. Second light ray 472A may be subtended by reflector 430 only once before proceeding out of reflector 430 through forward opening 442. Second light ray 472A may be passed out of internal space 441 as second subtended light ray 472B.

In another example, a third light ray 473A may represent light emitted from LEDs 470 at a second angle of inclination with respect to first light ray 471A. The second angle of inclination may be less than, equal to, or greater than the first angle of inclination (e.g., greater, as exemplified in FIG. 4B). Third light ray 473A may be subtended by reflector 430 only once before proceeding out of reflector 430 through forward opening 442. Third light ray 473A may be passed out of internal space 441 as third subtended light ray 473B. In another example, a fourth light ray 474A may represent light emitted from LEDs 470 at a third angle of inclination with respect to first light ray 471A. The third angle of inclination may be less than, equal to, or greater than the second angle of inclination (e.g., greater, as exemplified in FIG. 4). Fourth light ray 474A may proceed out of reflector 430 through forward opening 442 without being subtended by reflector 430.

Further, fourth light ray 474A may represent an extreme boundary of the effective span of light emitted by LEDs 470 (e.g., light emitted above a specified intensity). Alternatively, fourth light ray 474A may represent an extreme boundary of the total span of light emitted by LEDs 470 (e.g., the light ray proceeding from LEDs 470 at the greatest angle with respect to first light ray 471A), such that third light ray 473A may represent an extreme boundary of the effective span of light emitted by LEDs 470. Alternatively, third light ray 473A may represent an extreme boundary of the total span of light emitted by LEDs 470 (e.g., as exemplified in FIG. 4A).

For example, the angle between first light ray 471A and fourth light ray 473A may be between about 45 degrees and about 90 degrees (e.g., about 60 degrees). Although not illustrated in FIG. 4B, a person of ordinary skill in the art will appreciate that light rays may be emitted oppositely of the span between first light ray 471A and fourth light ray 474A (e.g., on the other side of the axis of symmetry of LEDs 470).

Light rays 471A-474A may serve as examples of light ray boundaries between portions of the effective and/or total spans of emitted light, where each light ray denotes a boundary between different ways in which the spans of light are subtended. For example, light rays emitted between third light ray 473A and second light ray 472A may each be subtended (e.g., reflected) by reflector 430 only once before proceeding out of reflector 430. In another example, light rays emitted between second light ray 472A and first light ray 471A may each be subtended (e.g., reflected) by reflector 430 two times before proceeding out of reflector 430. Thus, second light ray 472A may represent a boundary between light rays subtended once and light rays subtended twice by reflector 430.

In another example, light rays emitted between fourth light ray 474A and third light ray 473A may proceed out of reflector 430 without being subtended. Thus, third light ray 473A may represent a boundary between light rays subtended once and light rays not subtended by reflector 430. In another example, light rays emitted beyond first light ray 424A (e.g., opposite of the axis of symmetry of LEDs 470) may be further divided into smaller spans by one or more additional boundaries.

Subtended light rays 471B-473B may serve as examples of light ray boundaries of subtended light resulting from corresponding light rays 471A-473A. For example, subtended light ray 473B may proceed out of reflector 430 in a first direction (as exemplified in FIG. 4). In another example, subtended light ray 472B may proceed out of reflector 430 in a second direction (as exemplified in FIG. 4). The approximate angular difference between subtended light rays 473B and 472B (e.g., between the first and second directions) may represent a subtended span of light between about 60 degrees and about 120 degrees (e.g., about 90 degrees, as exemplified in FIG. 4B).

Thus, the span of emission between second and third light rays 472A, 473A may be converted into the subtended span between second and third subtended light rays 472B, 473B. For example, the emitted span between second and third light rays 472A, 473A may be less than the subtended span between second and third subtended light rays 472B, 473B. In another example, the emitted span may be focused to produce the subtended span having a wider angle of distribution than the emitted span.

In another example, first subtended light ray 471B may proceed out of reflector 430 in a direction within the subtended span between second and third subtended light rays 472B, 473B. Further, light rays emitted between first and second light rays 471A, 472A may also proceed out of reflector 430 within the subtended span between second and third subtended light rays 472B, 473B. Thus, the span of light emitted between first and second light rays 471A, 472A may be converted into a subtended span which lies within and/or overlaps with the subtended span between second and third subtended light rays 472B, 473B. In this way, one or more portions of the emitted span of light may be subtended into overlapping spans of subtended light, which may increase the intensity of a beam pattern resulting from the overlapping spans of subtended light.

Incidentally, where light is emitted between third and fourth light rays 473A, 474A, this light may not be subtended by reflector 430, and further may not proceed out of reflector 430 within the subtended span between second and third subtended light rays 472B, 473B. Light emitted between third and fourth light rays 473A, 474A may be light below the specified intensity associated with the effective span of light emitted from LEDs 470, and may not have a substantial effect on the overall intensity of the beam pattern resulting from the overlapping spans of subtended light.

Ellipsoidal surface 431 may be symmetric about an axis of symmetry 483 (e.g., corresponding to one or more of a major 381, minor 382, or intermediate axis 383 of the ellipsoid 380 of FIG. 3B). Further, LEDs 470 may be placed at a first position with respect to the axis of symmetry 483 (e.g., corresponding to a first focal point of the ellipsoidal surface 431). Thus light emitted from LEDs 470 may be subtended by reflector 430 along a number of paths (e.g., exemplified by light rays 471A-473A), such that each path may pass through a second position 475 (e.g., corresponding to a second focal point of the ellipsoidal surface 431) with respect to the axis of symmetry 483. The first and second positions may be symmetrical or non-symmetrical about axis of symmetry 483. Further, LEDs 470 may not represent a perfect point source of emitted light, such that the second position may not precisely represent a perfect focal point of subtended light. Further, the second position may be within reflector 430 (e.g., as exemplified in FIG. 4A), or may be exterior to reflector 430 (e.g., as exemplified in FIG. 4B).

In the embodiment of FIG. 4B, LEDs 470 may be positioned to be viewable through forward opening 442 and/or through a corresponding opening of a fixture (e.g., opening 102 of FIG. 1), such that LEDs 470 may be capable of emitting light directly through the opening. In this embodiment, a significant portion (e.g., about 90%) of light emitted by the LEDs may be subtended by reflector 430 before passing through forward opening 442. For example, direct emission of light and a miniscule amount of light absorption may account for as much as about 10% of light either passing through forward opening 442 directly or being absorbed by reflector 430.

In another embodiment, LEDs 470 may be positioned to be viewable through forward opening 442 of the fixture (e.g., and opening 102 of FIG. 1), but LEDs 470 may be oriented so that substantially all (e.g., 98%) of the light emitted by the LEDs is reflected before passing through forward opening 442. For example, approximately 2% of light may either be emitted directly through the opening or absorbed by reflector 430.

In yet another embodiment (e.g., the embodiment of FIG. 2), one or more LEDs may be positioned to be viewable through the opening of the fixture, but the LEDs may be oriented so that all (e.g., greater than about 99.6%) of the light is reflected before passing through the opening. For example, substantially no light (e.g., less than about 0.4%) may be passed directly through the opening or absorbed by the reflector.

In yet another embodiment, one or more LEDs may be positioned to be hidden (i.e. not viewable through the opening of the fixture). In this embodiment all the light emitted by the LEDs may be reflected before passing through the opening of the fixture. For example, light may be directed away from the opening so that no light passes through the opening directly, and only a miniscule amount of light may be absorbed by the reflector.

As illustrated in FIG. 5, light may be emitted by one or more LEDs (e.g., LEDs 520A, 520B, 520C) within a reflector 530 to produce a resulting beam pattern (e.g., beam pattern 1460 of FIG. 14). Reflector 530 may have an ellipsoidal surface 531, first and second flat surfaces 533, 534, and first and second parabolic surfaces 535, 536. Alternatively, first and second parabolic surfaces 535, 536 may be spherical. The first flat surface 533 and the first parabolic surface 535 may be positioned at one side of ellipsoidal surface 531. Further, the second flat surface 534 and the second parabolic surface 536 may be positioned oppositely (e.g., across a mirror image about a central plane of reflector 530 represented by light ray 521). In another example, first and second flat surfaces may be positioned at an angle with respect to a plane extending through minor and intermediate axes of an ellipsoid from which the ellipsoidal surface 531 has been formed (e.g., minor axis 382 and intermediate axis 383 of ellipsoid 380 in FIG. 3B). In another example, the angle between each flat surface and the plane extending though the minor and intermediate axes may be between about 20 degrees and about 70 degrees (e.g., about 45 degrees). First and second parabolic surfaces 535, 536 may be positioned within or partially within first and second flat surfaces 533, 534, respectively.

Each LED 520A-520C may emit light within a span of light ray distribution (e.g., approximately one hundred and twenty degrees). Some light rays may be emitted directly forwardly (e.g., as exemplified by central light ray 521) while other light rays may be emitted at various angles (e.g., as exemplified by light rays 524-529). Further, some light rays may be subtended (e.g., reflected) one or more times from the ellipsoidal surface 531 only (e.g., as exemplified by light rays 521, 524, 527) while others may be subtended from first and second flat surfaces 533, 534 only (e.g., as exemplified by light rays 525, 528), and still others may be subtended from first and second parabolic surfaces 535, 536 only (e.g., as exemplified by light rays 526, 529).

Some light rays may be subtended from two or more of the surfaces (e.g., a light ray may reflect from flat surface 533, then from ellipsoidal surface 531). A person of ordinary skill in the art will appreciate that light may reflect from ellipsoidal surface 531, first and second flat surfaces 533, 534, first and second parabolic surfaces 535, 536, or according to any combination thereof.

For example, central light ray 521 may be emitted from LED 520A. Although central light ray 521 is the only light ray shown emitting from LED 520A, a person of ordinary skill in the art will appreciate that the light ray distribution from LED 520A may be significantly more complex than that illustrated in FIG. 5. Thus, light rays emitted by LED 520A may reflect from one or more of the surfaces illustrated.

LED 520B may emit light rays 524, 525, and 526. Further, LED 520C may emit light rays 527, 528, and 529. A person of ordinary skill in the art will appreciate that the light ray distribution from LEDs 520B and 520C may be significantly more complex than that illustrated in FIG. 5. Thus, light rays emitted by LEDs 520B and 520C may reflect from one or more of the surfaces illustrated. In this example, light ray 524 may reflect from ellipsoidal surface 531 one or more times, and may pass from reflector 530 at an angle with respect to central light ray 521 (e.g., at about forty-five degrees). Further, light ray 527 may reflect from ellipsoidal surface 531 one or more times, and may pass from reflector 530 at an angle with respect to central light ray 521 (e.g., at about forty-five degrees opposite to light ray 524). Light rays 524, 527 may represent a maximum span of subtended light from reflector 530. Further, a span of light emission from the reflector 530 in the plane illustrated in FIG. 5 may be approximately the span between light ray 524 and light ray 527 (e.g., about ninety degrees). Thus, by optimizing dimensions of the ellipsoidal surface (e.g., length), a beam pattern may be configured from a specified angular span of subtended light.

LED 520B may emit light ray 525, which may reflect from first flat surface 533, and may further emit light ray 526, which may reflect from first parabolic surface 535. Light rays 525, 526 may pass within the angular span of subtended light passing from reflector 530. LED 520C may emit light ray 528, which may reflect from second flat surface 534, and may further emit light ray 529, which may reflect from second parabolic surface 536. Light rays 528, 529 may pass within the angular span of subtended light passing from reflector 530. Accordingly, the placement and orientation of first and second flat surfaces and first and second parabolic surfaces may aid in reflecting light so as to pass within the angular span of subtended light passing from reflector 530, which may further aid in generating a particular beam pattern.

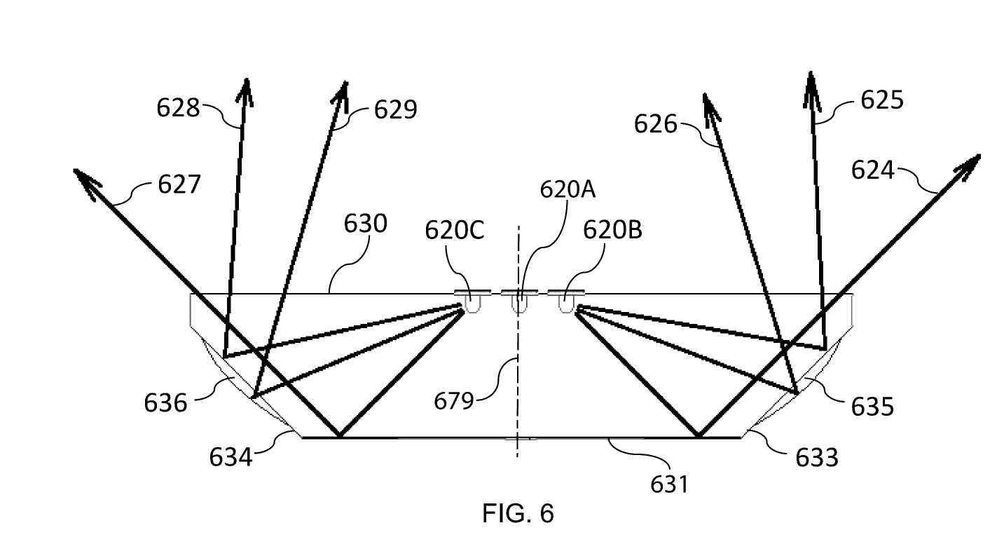

As illustrated in FIG. 6, light may be emitted by one or more LEDs (e.g., LEDs 620A, 620B, 620C) within a reflector 630 to produce a particular beam pattern (e.g., beam pattern 1460 of FIG. 14). Reflector 630 may have an ellipsoidal surface 631, first and second flat surfaces 633, 634, and first and second parabolic surfaces 635, 636. First flat surface 633 and first parabolic surface 635 may be positioned at one side of ellipsoidal surface 631. Further, second flat surface 634 and second parabolic surface 636 may be positioned oppositely (e.g., across a mirror image about a central plane 679 of reflector 630). The first and second flat surfaces 633, 634 may completely enclose the first and second parabolic surfaces 635, 636.

A person of ordinary skill in the art will appreciate that the light ray distribution from LEDs 620A-620C may be significantly more complex than that illustrated in FIG. 6. Thus, light rays emitted by LEDs 620A-620C may reflect from one or more of the surfaces illustrated. In one example, LED 620B may emit a light ray 624, which may be reflected by ellipsoidal surface 631 and proceed out at an angle to central plane 679 of reflector 630. For example, the angle between light ray 624 and central plane 679 may be between about 30 degrees and about 60 degrees (e.g., about 45 degrees). Likewise, LED 620C may emit a light ray 627, which may be reflected by ellipsoidal surface 631 and proceed out at an angle to central plane 679 of reflector 630 oppositely to light ray 624. For example, the angle between light ray 627 and central plane 679 may be between about 30 degrees and about 60 degrees (e.g., about 45 degrees). Thus light rays 624, 627 may approximately represent a span of light emission from reflector 630 (e.g., approximately ninety degrees from one extreme to the other). Other light rays (e.g., light rays 625, 626, 628, 629) may be emitted and may pass within the span of light emission between light rays 624, 627 (e.g., as a result of reflection from any one or from more than one of the ellipsoidal surface, the first and second flat surfaces, and/or the first and second parabolic surfaces).

First and second flat surfaces 633, 634, may each be oriented at an angle to central plane 679 of reflector 630. For example, first flat surface 633 may be at a first angle from central plane 679. First angle may be between about thirty degrees and about sixty degrees (e.g., about forty-five degrees). In another example, second flat surface 634 may be at a second angle from central plane 679. Second angle may be between about thirty degrees and about sixty degrees (e.g., about forty-five degrees, and oppositely from first flat surface 633). A person of ordinary skill in the art will appreciate that other orientations of the first and second flat surfaces 633, 634 may be possible.

Each parabolic surface 635, 636 may be formed within or adjacent each flat surface 633, 634, respectively. Each parabolic surface 635, 636 may further be oriented so that a corresponding vertex of each parabolic surface may be positioned farthest from each flat surface 635, 636, respectively (as exemplified in FIG. 6). A person of ordinary skill in the art will appreciate that other orientations of the first and second parabolic surfaces 635, 636 may be possible. Additional advantages of the first and second parabolic surfaces will be described in greater detail in other embodiments of the present invention.

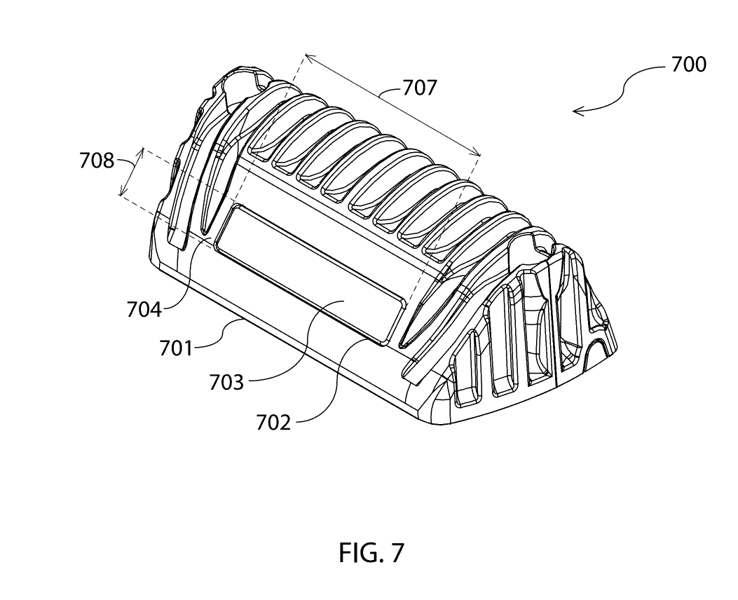

As illustrated in FIG. 7, a fixture 700 is exemplified which may include a housing 701 with an interior cavity (e.g., interior cavity 206 of FIG. 2). A reflector, one or more PCBAs, and one or more LEDs may be positioned within the interior cavity (e.g., as shown and described with reference to FIG. 2). Fixture 700 may further include an opening 702, which may extend entirely through a wall 704 of fixture 700. Opening 702 may be any suitable shape, and may have a predetermined area. For example, opening 702 may have a width 708 and a length 707 greater than width 708 (e.g., a rectangular slot). In a specific example, the ratio of length 707 to width 708 may be 1:1 or more (e.g., 5:1, 50:1, 500:1).

Opening 702 may be sized so that length 707 is approximately as long as the span between two sidewalls of the reflector positioned within the interior cavity (e.g., sidewalls 340 of reflector 330 in FIG. 3A may be spaced approximately by length 707). In another example, length 707 of opening 702 may be greater than the length of the span between the two sidewalls. In another example, the length 707 of opening 702 may be less than the length of the span between two sidewalls. Further, opening 702 may be sized so the width 708 is approximately as wide as a forward open portion of the reflector (e.g., forward opening 242 of reflector 230 in FIG. 2 may be as large as width 708). In another example, width 708 of opening 702 may be greater than the forward opening (e.g., as in FIG. 2). In another example, width 708 of opening 702 may be less than the forward opening (e.g., where opening 702 of FIG. 7 is combined with reflector 230 of FIG. 2).

Length 707 and width 708 of opening 702 may be large enough to allow all, substantially all, or a significant portion of light emitted by the one or more LEDs to pass through opening 702. For example, width 708 may be reduced to a value corresponding to a lesser distance (e.g., distance 444 of FIG. 4A) through which light may be emitted from the reflector (e.g., reflector 430 of FIG. 4A). The value of width 708 may be selected to allow a threshold amount of light to be emitted to obtain a particular beam pattern, or to obtain a predetermined amount of luminous intensity, or both. The critical width value may refer to the amount of light at which luminous intensity begins to significantly decrease as a result of a further decrease in width 708. Accordingly, any changes in which width 708 is greater than the critical width value may not have a substantial effect on luminous intensity.

Width 708, as exemplified in FIG. 7, may be less than or equal to corresponding widths exemplified in other embodiments (e.g., width 108 of FIG. 1). Further, width 708 may be less than, equal to, or greater than the forward opening of the reflector (e.g., forward opening 242 of FIG. 2). For example, width 708 may be between about 1.25 and about 0.75 times the size of the forward opening (e.g., about 1 times the size of the forward opening of the reflector). In another embodiment, width 708 may be between about 0.5 and about 0.75 times the size of the forward opening (e.g., about 0.65). In yet another embodiment, width 708 may be between about 0.25 and about 0.5 times the size of the forward opening (e.g., about 0.25). In yet another embodiment, width 708 may be less than about 0.25 the size of the forward opening (e.g., about 0.15).

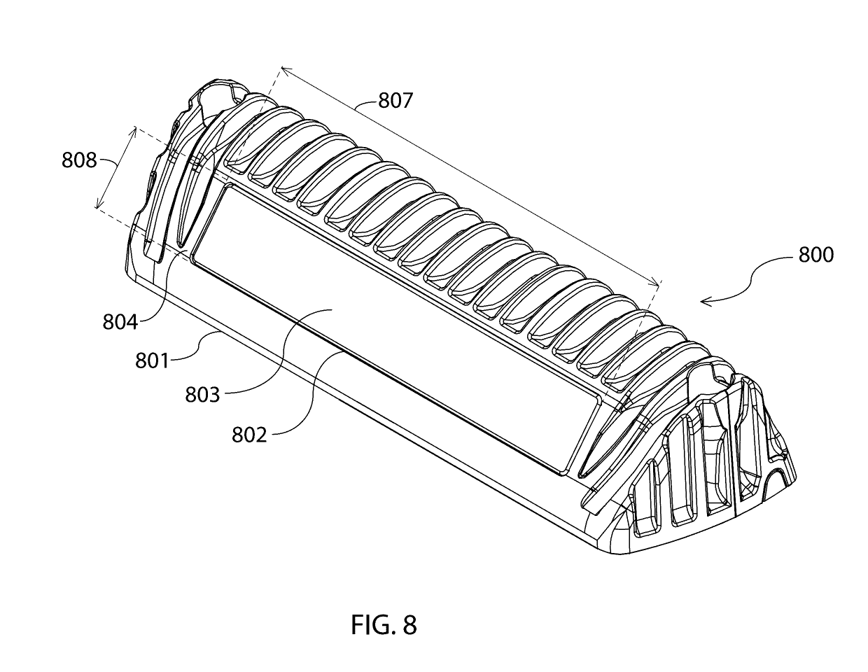

As illustrated in FIG. 8, a fixture 800 is exemplified which may include a housing 801 with an interior cavity (e.g., interior cavity 206 of FIG. 2), and an opening 802 extending through a sidewall 804 of the housing 801. A reflector, one or more PCBAs, and one or more LED's may be positioned within housing 801 (e.g., as shown and described with reference to FIG. 2). Opening 802 may have a predetermined area. For example, opening 802 may have a width 808 and a length 807 longer than width 808.

Length 807, as exemplified in FIG. 8, may be greater than or equal to corresponding lengths exemplified in other embodiments (e.g., length 107 of FIG. 1). For example, the ratio of length 807 to corresponding lengths exemplified in other embodiments may be 1:1 or greater (e.g., 2:1, 20:1, 200:1). In one embodiment, the reflector contained within housing 801 may be correspondingly longer. For example, the reflector may be approximately the same length as opening 802 (e.g., length 807), or may be longer or shorter to accommodate design considerations. In this embodiment, more LEDs may be integrated with the PCB. For example the PCB may be equipped with three, four, five, six, seven, eight, nine, or more LEDs.

In another embodiment, the reflector positioned within housing 801 may be a series of reflectors positioned in a side-by-side or a top-to-bottom relationship. For example, a series of reflectors may include two or more reflectors. Further, the reflector may be an array of reflectors positioned in both a side-by-side and a top-to-bottom relationship (e.g., in a reflector grid or matrix). Each reflector may, for example, be larger, similarly sized, or smaller than the reflector illustrated in FIG. 3A. For example, in a series of two reflectors, a first reflector may have a larger dimensional length than the reflector illustrated in FIG. 3A, and a second reflector may have a smaller dimensional length than the reflector illustrated in FIG. 3A. Each reflector may be associated with one or more LEDs. For example, each reflector may be associated with one, two, three, four, or more LEDs. Where two or more reflectors are included in a series of reflectors, each reflector may be associated with a different or the same number of LEDs. For example, in a series of two reflectors, a first reflector may be associated with three LEDs and a second reflector may be associated with five LEDs. Further, each reflector may be associated with a single PCBA. Alternatively, each reflector may be associated with corresponding PCBAs.

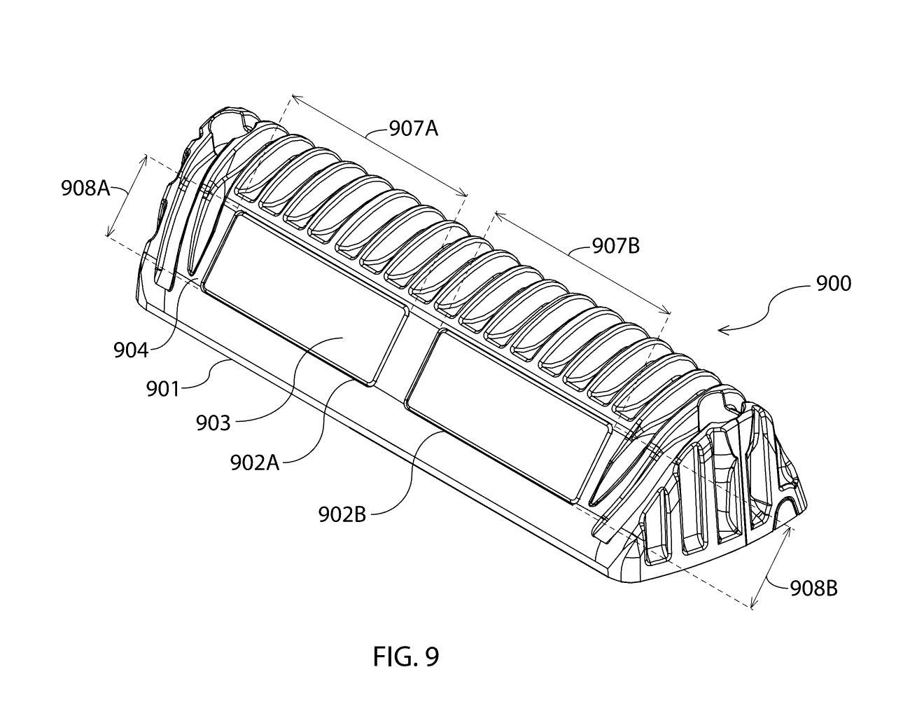

As illustrated in FIG. 9, a fixture 900 is exemplified which may include a housing 901 with an interior cavity (e.g., interior cavity 206 of FIG. 2), and two or more openings (e.g., openings 902A, 902B) extending through a sidewall 904. For example, housing 901 may include three, four, five, six, or more openings. Each of the two or more openings may have corresponding predetermined areas. A reflector, one or more PCBAs, and one or more LEDs may be positioned within housing 901.

For example, each opening may have its own length and width. In FIG. 9, opening 902A may have a length 907A and a width 908A and opening 902B may have a length 907B and a width 908B. The lengths and widths of each opening may have the same dimensions, or may be different. For example, openings 902A and 902B are shown having equivalent lengths and widths (e.g., length 907A may be equal to length 907B, and width 908A may be equal to width 908B as exemplified in FIG. 9). Each opening may have a corresponding reflector, corresponding LEDs, and/or a corresponding PCBA.

In another example, housing 901 may receive a single reflector, a single PCB, and one or more LEDs. Accordingly, light may be emitted by the one or more LEDs and the single reflector may reflect a significant portion, substantially all, or all the light through two or more openings. In another embodiment, housing 901 may receive a reflector for each opening, respectively. Reflectors may have the same or different dimensions. Similar or different numbers of LEDs may be associated with each reflector. Housing 901 may receive a single PCBA, which may be capable of mounting with each reflector and corresponding LEDs. For example, first and second reflectors may be mounted along a length of a single PCBA to reflect light through corresponding first and second openings, the reflectors may have the same width, but different lengths such that the openings also have different lengths, and one reflector may include two LEDs while the other reflector includes four LEDs. A person of ordinary skill in the art will appreciate that alternative combinations may be possible.

In another embodiment, housing 901 may receive a reflector, a PCB, and one or more LEDs for each opening, individually. Reflectors and PCBs may have the same or different dimensions. The same or different numbers of LEDs may be associated with each reflector. For example, first and second reflectors may be mounted to corresponding first and second PCBs to reflect light through corresponding first and second openings, the reflectors may have the different widths, but the same length such that the openings also have different widths, and each reflector may include three LEDs. A person of ordinary skill in the art will appreciate that alternative combinations may be possible.

With regard to the embodiments above, each of the reflectors which may be contained within compartment 901 may be have a length (e.g., longer, similar in length, or shorter than reflector 330 illustrated in FIG. 3A). Accordingly, each opening may have dimensions (e.g., longer, similar in length, or shorter and wider, similar in width, or narrower than opening 102 illustrated in FIG. 1). Each reflector positioned in housing 901 may be positioned side-by-side or top-to-bottom (e.g., a series of reflectors). Alternatively, each reflector contained in compartment 901 may be positioned in both a side-by-side and a top-to-bottom relationship (e.g., a grid or matrix of reflectors).

In addition to the embodiments herein discussed, a person of ordinary skill in the art will appreciate that elements of various embodiments of the present invention may be combined to create new combinations of elements. Furthermore, it is understood that each of these embodiments may include a media 903 covering each opening corresponding to emitted light from a reflector in the system, or a media spanning multiple openings where such a configuration would be appropriate.

Media 903 may include any of a plurality of pigments or colors to filter the color of light passing through media 903. Further, where more than one media is used (e.g., to cover more than one opening), each media may include similar or different pigments and/or colors so as to filter similar or different colors of light. Further, a single media 903 may include more than one pigment and/or color, such that the single media 903 may filter more than one color of light, or a blend of colors.

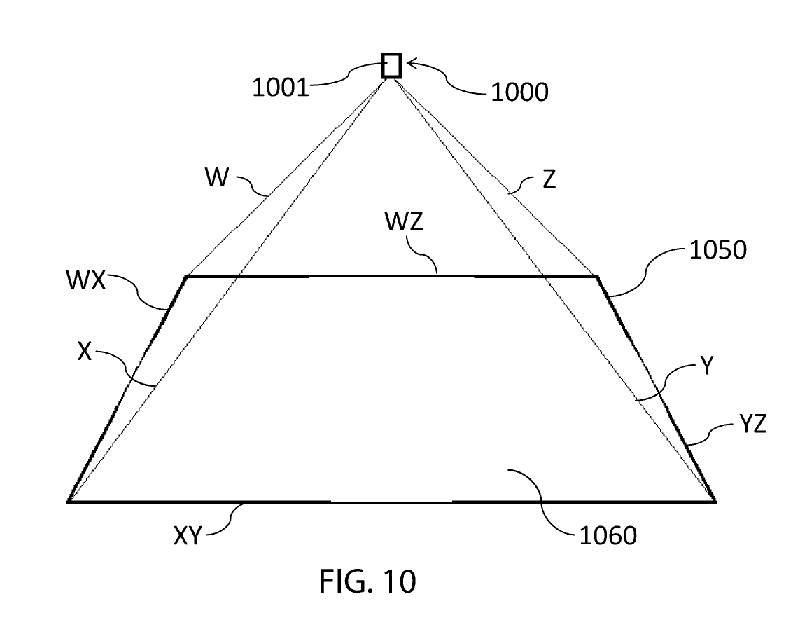

As illustrated in FIG. 10, a fixture 1000 is exemplified which may be positioned over a surface 1050 to emit light toward surface 1050. Fixture 1000 may include a housing 1001 having at least one opening (e.g., opening 102 of FIG. 1). At least one reflector, at least one PCB, and at least one LED may be positioned within housing 1001. Light may be emitted by the LED, such that emitted light may be subtended by the reflector to pass through the opening according to a predetermined beam pattern 1060. For example, fixture 1000 may be any of the fixtures discussed herein (e.g., one of fixtures 100, 200, 700, 800, or 900) or equivalents thereto. Further, the at least one reflector may be any of the reflectors discussed herein (e.g., as discussed with reference to FIGS. 1-9).

Lines W, X, Y, and Z are for illustration only, and may convey a maximum span of light ray emission in three dimensional space. For example, line W and line Z may be offset by an angular span of light ray emission (e.g., approximately ninety degrees). Further, line X and line Y may be offset by an angular span of light ray emission (e.g., approximately ninety degrees). Thus, a first plane passing through lines W and X may be oriented at an angle to a second plane passing through lines Y and Z (e.g., at approximately ninety degrees). The angular span between the first and second planes may be a result of the shape of the reflector (e.g., as described with respect to reflector 430 of FIG. 4).

In another example, line W and line X may be offset by an angular span of light ray emission (e.g., approximately ninety degrees). Further, line Y and line Z may be offset by an angular span of light ray emission (e.g., approximately ninety degrees). Thus, a third plane passing through lines X and Y may be oriented at an angle to a fourth plane passing through lines W and Z (e.g., at approximately ninety degrees). The angular span between the first and second planes may be a result of the shape of the reflector (e.g., as described with respect to either reflector 530 of FIG. 5 or reflector 630 of FIG. 6).

Each of the first, second, third, and fourth planes may intersect surface 1050 at lines WX, YZ, XY, WZ, respectively. Lines WX, YZ, XY, and WZ are for illustration only, and may convey a maximum zone for beam pattern 1060 on surface 1050. Thus lines W, X, Y, Z, WX, XY, YZ, WZ may form a quadrangular prism shape (e.g., a pyramid). In this example, lines WX, XY, YZ, WZ may form a four-sided perimeter (e.g., a square).

Beam pattern 1060 may be less than or equal to the area within the perimeter formed by lines WX, XY, YZ, WZ. For example, beam pattern 1060 may have rounded edges, such that any light traveling outside of beam pattern 1060 but within the perimeter is substantially reduced as compared to the light emitted within beam pattern 1060. Thus, beam pattern 1060 created by light emitted by fixture 1000 may resemble a four-sided shape with rounded corners. Where an embodiment includes more than one reflector and passing light through more than one opening, the beam pattern 1060 of FIG. 10 may be repeated along the length or width of the fixture 1000. For example, each of the beam patterns created by light emitted through respective openings may be oriented so that they are overlapping. It may also be possible to position more than one fixture over an area to be lighted. Each fixture may be spaced apart so that respective beam patterns are overlapping or separated (e.g., dark regions between lighted areas).

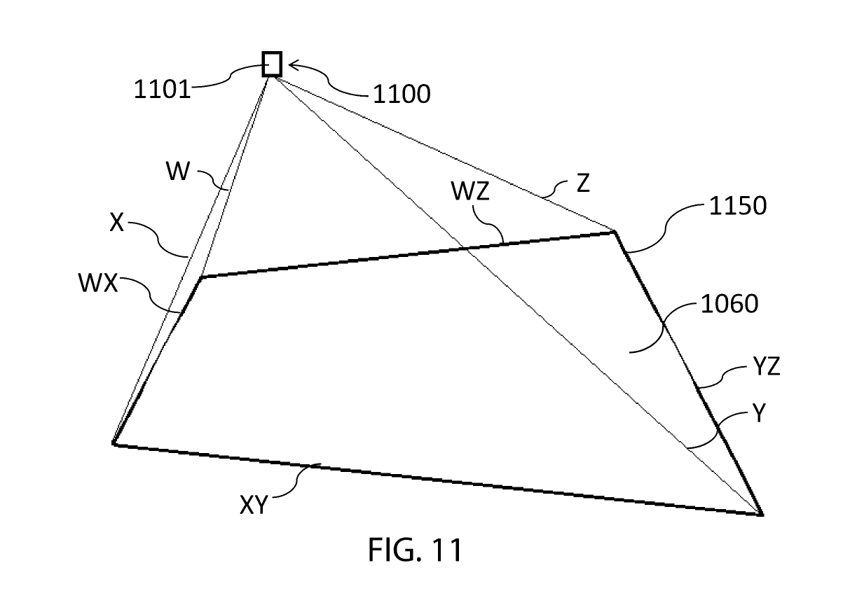

As illustrated in FIG. 11, a fixture 1100 is exemplified which may be positioned over a surface 1150 to emit light toward the surface 1150. Fixture 1100 may include a housing 1101 having at least one opening, at least one reflector, at least one PCB, and at least one LED positioned therein. Light may be emitted by the LED, such that emitted light may be reflected off of the reflector to pass through the opening according to a predetermined beam pattern 1160. For example, fixture 1100 may be any of the fixtures discussed herein (e.g., fixtures 100, 200, 700, 800, or 900) or equivalents thereto. Further, the at least one reflector may be any of the reflectors discussed herein (e.g., as discussed with reference to FIGS. 1-9).

Lines W, X, Y, and Z are for illustration only, and may convey a maximum span of light ray emission in three dimensional space. For example, line W and line Z may be offset by an angular span of light ray emission (e.g., approximately ninety degrees). Further, line X and line Y may be offset by an angular span of light ray emission (e.g., approximately ninety degrees). Thus, a first plane passing through lines W and X may be oriented at an angle to a second plane passing through lines Y and Z (e.g., at approximately ninety degrees). The angular span between the first and second planes may be a result of the shape of the reflector (e.g., as described with respect to reflector 430 of FIG. 4).

In another example, line W and line X may be offset by an angular span of light ray emission (e.g., approximately ninety degrees). Further, line Y and line Z may be offset by an angular span of light ray emission (e.g., approximately ninety degrees). Thus, a third plane passing through lines X and Y may be oriented at an angle to a fourth plane passing through lines W and Z (e.g., at approximately ninety degrees). The angular span between the first and second planes may be a result of the shape of the reflector (e.g., as described with respect to either reflector 530 of FIG. 5 or reflector 630 of FIG. 6).

Each of the first, second, third, and fourth planes may intersect the surface 1150 at lines WX, YZ, XY, WZ, respectively. Lines WX, YZ, XY, and WZ are for illustration only, and may convey a maximum zone for beam pattern 1160 on surface 1150. Fixture 1100 and/or the reflector may be rotated to change the beam pattern 1160 (e.g., different than beam pattern 1060 of FIG. 10). For example, fixture 1100 and/or the reflector may be rotated about an axis created by the intersection of the first and second planes (e.g., counter-clockwise in FIG. 11).

In this example, the rotation of beam pattern 1160 may cause lines WX and YZ to move to the right in FIG. 11 (e.g., as compared to FIG. 10). Further, lines W, X, and WX may shorten and lines Y, Z, and YZ may lengthen (e.g., as a result of a change in distance between fixture 1100 and surface 1150 as the lines move to the right). Thus, by rotating the fixture 1100 and/or the reflector, beam pattern 1160 may be modified and/or deformed into a different shape. For example, lines W, X, Y, Z, WX, XY, YZ, WZ may form a quadrangular prism shape. In this example, lines WX, XY, YZ, WZ may form a four-sided perimeter (e.g., a trapezoid).

In another example, fixture 1100 and/or the reflector may be rotated about an axis created by the intersection of the third and fourth planes. In this embodiment, a quadrangular prism shape may also be created with a four-sided beam pattern (e.g., a trapezoid). In another example, fixture 1100 and/or the reflector may be rotated about any other axis. Rotation about other axes may enable the creation of beam patterns having other shapes (e.g., parallelogram, rhombus, square, triangle). Additionally, fixture 1100 may be moved closer to or further from the surface 1150 to change the intensity of the beam pattern 1160.

Beam pattern 1160 may be less than or equal to the area within the perimeter. For example, beam pattern 1060 may have rounded edges, such that any light traveling outside of beam pattern 1160 but within the perimeter is substantially reduced as compared to the light emitted within beam pattern 1160. Thus, beam pattern 1160 created by light emitted by fixture 1100 may resemble a three or four-sided shape with rounded corners. This shape is distinguished from a circle or oval beam pattern produced by prior art lighting fixtures.

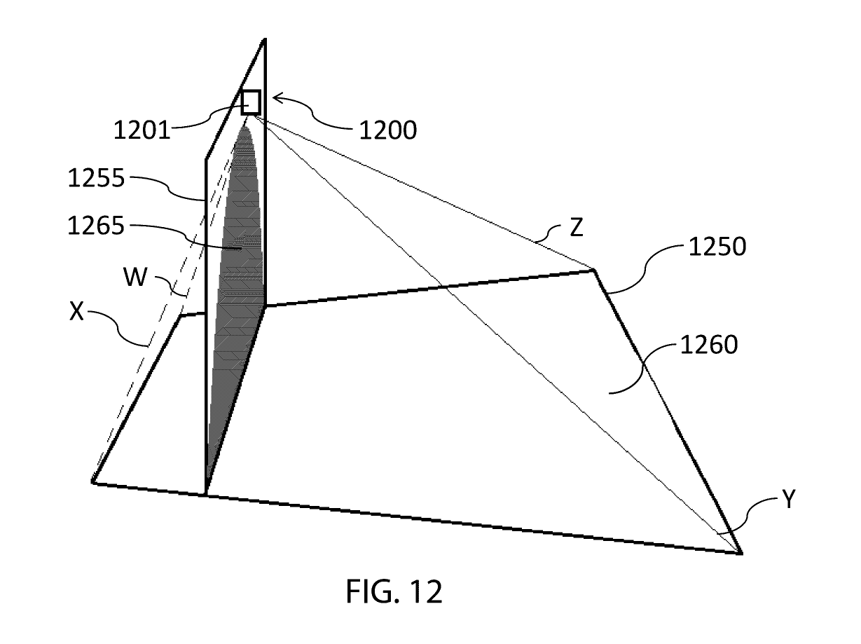

As illustrated in FIG. 12, a fixture 1200 is exemplified which may be positioned a first distance from a first surface 1250 and a second distance from a second surface 1255. For example, the first distance may be less than, equal to, or greater than the second distance. As an example, the first distance may be substantially larger than the second distance. As another example, the second distance may be zero (e.g., the fixture 1200 may be mounted directly to second surface 1255). Fixture 1200 may emit light toward one or both of the first and second surfaces 1250, 1255 (e.g., as exemplified in FIG. 12).

Fixture 1200 may include a housing 1201 having at least one opening, at least one reflector, at least one PCB, and at least one LED positioned therein. Light may be emitted by the LED, such that emitted light may be reflected off of the reflector to pass through the opening according to predetermined beam patterns 1260, 1265, on first and second surfaces 1250, 1255, respectively. For example, fixture 1200 may be any of fixtures discussed herein (e.g., fixtures 100, 200, 700, 800, or 900) or equivalents thereto. Further, the at least one reflector may be any of the reflectors discussed herein (e.g., with reference to FIGS. 1-9).

Lines W, X, Y, and Z are for illustration only, and may convey a maximum span of light ray emission in three dimensional space. Portions of lines W and X are shown in phantom to represent the path of travel of light without the addition of second surface 1255. Accordingly, light that would pass onto surface 1250 (e.g., as exemplified in FIG. 11) may be obstructed by surface 1255. It may also be possible that surface 1255 may be transparent or semi-transparent, such that some portion of light emitted by the fixture 1200 may pass onto the portion of surface 1250 behind surface 1255.

Lines W, X, Y, and Z may be offset from each other by similar or different angular spans of light ray emission (e.g., as described with reference to FIGS. 10 and 11). The respective angular spans may be a result of the shape of the reflector (e.g., as described with respect to reflector 430 of FIG. 4, reflector 530 of FIG. 5, and/or reflector 630 of FIG. 6). Further, a maximum zone for beam patterns 1260, 1265 are created on one or both of the first and second surfaces 1250, 1255, respectively. The zone may be altered by rotating fixture 1200 and/or the reflector positioned therein along any suitable axis. For example, fixture 1200 may be mounted such that a beam pattern may be created on the first surface 1250 only. In another example, the fixture 1200 may be mounted such that beam patterns may be created on both the first surface 1250 and the second surface 1255. In yet another example, the fixture 1200 may be mounted such that a beam pattern may be created on the second surface 1255 only.

A fixture may also be positioned with respect to three or more surfaces. Thus, the fixture may be capable of creating beam patterns on each or any combination of the three or more surfaces. The three or more surfaces may be orthogonal to each other, or may be at any other angle to each other. Further, the fixture may be positioned with respect to flat or uneven surfaces, transparent, semi-transparent, or non-transparent surfaces, and/or with respect to an open space (e.g., as on an aircraft in flight, such that the fixture directs all light away from the aircraft but not on to any particular surface).

Where an embodiment is used including more than one reflector and passing light through more than one opening, the beam patterns 1260, 1265 may be repeated along the length or width of the fixture 1200. For example, each of the beam patterns created by light emitted through respective openings may be oriented so that they are overlapping. It may also be possible to position more than one fixture over an area to be lighted. Each fixture may be spaced apart so that respective beam patterns may be overlapping or separated (e.g., dark regions between lighted areas). Where two or more fixtures are positioned with respect to two or more surfaces, each fixture may emit light onto one or more of the two or more surfaces. For example, in a system having two fixtures and two surfaces, the first fixture may emit light onto the first surface only and the second fixture may emit light onto both surfaces. A person of ordinary skill in the art will appreciate that many combinations are possible.

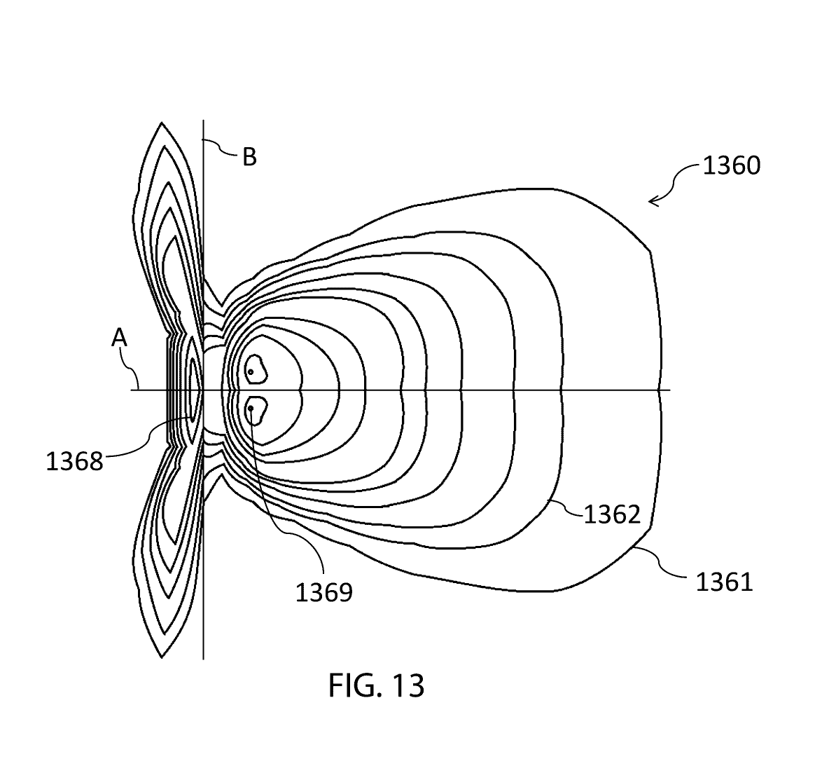

As illustrated in FIG. 13, a fixture (e.g., light fixture 100 of FIG. 1) may be positioned to emit a beam pattern 1360 onto a first surface. The beam pattern 1360 may be shown with one or more semi-concentric rings (e.g., rings 1361, 1362, 1368, 1369, and others not labeled). Each ring may represent a boundary between lower and higher luminous intensities of light emitted on the surface. For example, a low luminous intensity of light may be emitted outside the first ring 1361, which light may be below a first threshold value (e.g., less than 0.10 lux). Similarly, light emitted outside the second ring may be below a second threshold value (e.g., less than 0.20 lux). Thus, intensity may fluctuate from the first threshold value at the first ring 1361 to a second threshold value at the second ring 1362.

The threshold values of each successive ring may increase by substantially the same amount of luminous intensity up to the innermost ring 1369 (e.g., the 11th ring). Further, the innermost ring 1369 may have an innermost luminous intensity value.

A focus point may be defined to be the point at which intensity reaches its greatest value. Thus, the point of greatest intensity, or focus point, of beam pattern 1360 (e.g., the brightest point) may be inside the innermost ring 1369. A beam pattern may have one or more focus points. Where a beam pattern has two or more focus points, the focus points may have approximately equal or different luminous intensity values. Where the focus points are different, the greater value or values may be referred to as the major focus point or points and the lesser value or values may be referred to as the minor focus point or points. As shown in FIG. 13, it may be possible to have a plurality of focus points. In FIG. 13, two major focus points may exist, one within the innermost ring 1369 and the other within the corresponding ring opposite line A (e.g., each corresponding to an 11^{th} ring). Additionally, a minor focus point may exist within ring 1368 (e.g., corresponding to a 7^{th} ring).

Line A may represent a line of symmetry extending through the beam pattern 1360. Line A may correspond to a plane of symmetry extending through the fixture and/or a reflector positioned within the fixture. Line B may represent the location for placement of a second surface at an angle to the first surface (e.g., surface 1255 may be orthogonally placed with respect to surface 1250 in FIG. 12). Thus, beam pattern 1360 may be emitted onto two surfaces. The second surface may be placed at any angle and at any location with respect to the first surface. Accordingly, in this example, the portion of beam pattern 1360 falling to the left of line B may be emitted onto or through the second surface (e.g., second surface 1255 of FIG. 12) whereas the portion of the beam pattern 1360 falling to the right of line B may be emitted onto or through the first surface (e.g., first surface 1250 of FIG. 12).

Though not illustrated in FIG. 13, the fixture may contain at least one reflector. The reflector may include at least one surface shape. For example, the reflector may be one or more of a parabolic, spherical, ellipsoidal, cylindrical, conical, toroidal, and a flat shape, or a plurality of one or more of the foregoing shapes. The reflector producing beam pattern 1360 may include an ellipsoidal shape (e.g., ellipsoidal shape 531 of FIG. 5) and at least two flat shapes (e.g., first and second flat shapes 533, 534 of FIG. 5).

Notably, the beam pattern 1360 may exhibit some desirable features and some undesirable features. For example, the portion of the beam falling to the right of line B may be substantially uniform (e.g., producing a trapezoid shaped pattern with rounded corners). However, the portion of the beam falling to the left of line B may be substantially non-uniform (e.g., bifurcated into two hot spots). Therefor the additional advantages of the use of one or more parabolic surfaces may become apparent with respect to other embodiments of the present invention.

As illustrated in FIG. 14, a fixture (e.g., light fixture 100 of FIG. 1) may be positioned to emit a beam pattern 1460 onto a first surface. The beam pattern 1460 may be shown with one or more semi-concentric rings (e.g., rings 1461, 1462, 1468, 1469, and others not labeled). Each ring may represent a boundary between lower and higher luminous intensities of light emitted on the surface where the innermost ring 1369 may have the greatest luminous intensity. Thus the point of greatest intensity, or focus point (e.g., the brightest point) inside beam pattern 1460 may be inside the innermost ring 1369.

In FIG. 14, two major focus points may exist, one within the innermost ring 1469 and the other within the corresponding ring opposite line A (e.g., each corresponding to an 11^{th} ring). Additionally, a minor focus point may exist within ring 1468 (e.g., corresponding to a 6^{th} ring).

Line A may represent a line of symmetry extending through the beam pattern 1360. Line A may correspond to a plane of symmetry extending through the fixture and/or a reflector positioned within the fixture. Line B may represent the location for placement of a second surface (e.g., second surface 1255 of FIG. 12) at an angle to the first surface. Accordingly, some of beam pattern 1460 may fall onto or through the second surface and some of beam pattern 1460 may fall onto or through the first surface.

Though not illustrated in FIG. 14, the fixture may contain at least one reflector. The reflector may include at least one surface shape. For example, the reflector may be one or more of a parabolic, spherical, ellipsoidal, cylindrical, conical, toroidal, and a flat shape, or a plurality of one or more of the foregoing shapes. The reflector producing beam pattern 1460 may include an ellipsoidal shape, at least two flat shapes, and at least two parabolic shapes. The parabolic shapes may be at least partially contained within the flat shapes.

Notably, the beam pattern 1460 has multiple desirable features. For example, the portion of the beam falling to the right of line B is substantially uniform (e.g., producing a trapezoid shaped pattern with rounded corners), and the portion of the beam falling to the left of line B is substantially uniform (e.g., part of the trapezoid shaped pattern). Thus, the use of one or more parabolic surfaces may facilitate the lessening or removal of hot spots and/or non-uniformities from the beam pattern produced by the fixture.

Other aspects and embodiments of the present invention will be apparent to those skilled in the art from consideration of the specification and practice of the invention disclosed herein. It is intended, therefore, that the specification and illustrated embodiments be considered as examples only, with a true scope and spirit of the invention being indicated by the following claims.

What is claimed is:

1. An apparatus, comprising:
a fixture including a slot;
one or more LEDs positioned within the fixture and configured to emit an effective span of light, such that the effective span of light does not pass through the slot; and
a reflector positioned within the fixture and configured to produce subtended light by subtending the effective span of light, such that the subtended light passes through the slot, wherein the reflector is formed of at least one ellipsoidal surface, at least one flat surface, and at least one parabolic surface.

2. The apparatus of claim 1, wherein the at least one flat surface includes a first and a second flat surface.

3. The apparatus of claim 1, wherein the at least one ellipsoidal surface is formed of a portion of an ellipsoid having a major axis, a minor axis, and an intermediate axis.

4. The apparatus of claim 3, wherein the at least one flat surface is positioned at an angle with respect to a plane extending through the minor and the intermediate axes of the ellipsoid, such that the subtended light passes through the slot in a first span corresponding to a width dimension of the apparatus.

5. The apparatus of claim 3, wherein the at least one ellipsoidal surface is formed by the portion of the ellipsoid extending along a linear distance of the major axis and about an angle of rotation about the major axis.

6. The apparatus of claim 5, wherein the angle of rotation about the major axis is formed by a first and a second angle, wherein the first angle extends from the intermediate axis toward the minor axis, and wherein the second angle extends oppositely from the first angle, such that subtended light passes through the slot in a second span corresponding to a height dimension of the apparatus.

7. The apparatus of claim 6, wherein the second angle is greater than the first angle.

8. The apparatus of claim 1, wherein the at least one parabolic surface includes a first parabolic surface and a second parabolic surface.

9. The apparatus of claim 1, wherein the at least one parabolic surface extends from the flat surface to prevent subtended light from forming hot spots in the subtended light.

10. An apparatus, comprising:
a fixture including a slot with a predefined area formed by a length and a width;
one or more LEDs positioned within the fixture and configured to emit an effective span of light, such that the effective span of light does not pass through the slot; and
a reflector positioned within the fixture and configured to produce subtended light by subtending the effective span of light, such that substantially all the subtended light passes through the predefined area of the slot, wherein the reflector is formed of at least one ellipsoidal surface and one or more non-ellipsoidal surfaces.

11. The apparatus of claim 10, wherein the length is greater than the width.

12. The apparatus of claim 10, wherein substantially all the subtended light passes through the predefined area within a critical width value extending across the width.

13. The apparatus of claim 12, wherein the width is greater than the critical width value.

14. The apparatus of claim 12, wherein the width is equal to the critical width value.

15. A method, comprising:
emitting light from one or more LEDs toward a reflector; and
subtending the emitted light from at least one ellipsoidal surface, at least two flat surfaces, and at least two parabolic surfaces of the reflector through a slot of a fixture.

16. The method of claim 15, wherein light subtended by the at least two flat surfaces passes through the slot of the fixture in a first span corresponding to a width of the fixture.

17. The method of claim 16, wherein the at least two parabolic surfaces are each positioned on one of the at least two flat surfaces, and are configured to prevent formation of hot spots in the emitted light subtended by the at least two flat surfaces.

18. The method of claim 16, wherein light subtended by the at least one ellipsoidal surface passes through the slot of the fixture in a second span corresponding to a height of the fixture.

19. The method of claim 15, wherein a portion of the light emitted by the one or more LEDs is subtended at least once by one or more of the at least one ellipsoidal surface, the at least two flat surfaces, and the at least two parabolic surfaces.

20. The method of claim 15, wherein a portion of the light emitted by the one or more LEDs is subtended at least twice by one or more of the at least one ellipsoidal surface, the at least two flat surfaces, and the at least two parabolic surfaces.
